(19) United States
(12) Patent Application Publication
(10) Pub. No.: US 2016/0109738 A1
(43) Pub. Date: Apr. 21, 2016

(54) DISPLAY PANEL AND METHOD OF MANUFACTURING THE SAME

(71) Applicant: Samsung Display Co., Ltd., Yongin-si (KR)

(72) Inventors: Junseok LEE, Seoul (KR); Seung jun YU, Cheonan-si (KR); Sang-Myoung LEE, Seoul (KR); DoYeong PARK, Seoul (KR); SangWoo WHANGBO, Seoul (KR)

(21) Appl. No.: 14/819,202

(22) Filed: Aug. 5, 2015

(30) Foreign Application Priority Data
Oct. 17, 2014 (KR) 10-2014-0140520

(51) Int. Cl. G02F 1/1337; G02F 1/1341; G02F 1/1339

(52) U.S. Cl. CPC G02F 1/1337; G02F 1/1339; G02F 1/1341

(57) ABSTRACT

A display panel includes a first display substrate, a second display substrate facing the first display substrate and coupled with the first display substrate, a liquid crystal layer interposed between the first display substrate and the second display substrate, and an alignment layer disposed at a display area of at least one display substrate selected from the first and second display substrates. The selected display substrate includes a first area provided with a surface having a hydrophobic property higher than a hydrophobic property of an area adjacent to the first area.

### CLAIM OF PRIORITY

This application makes reference to, incorporates the same herein, and claims all benefits accruing under 35 U.S.C. §119 from an application earlier filed in the Korean Intellectual Property Office on 17 Oct. 2014 and there duly assigned Serial No. 10-2014-0140520.

### BACKGROUND OF THE INVENTION

1. Field of the Invention

Embodiments of the present disclosure relate to a display panel and a method of manufacturing the same. More particularly, embodiments of the present disclosure relate to a display panel capable of preventing an alignment layer solution from spreading during formation of an alignment layer and a method of manufacturing the display panel.

2. Description of the Related Art

In general, a liquid crystal display includes a thin film transistor substrate, a color filter substrate, and a liquid crystal layer interposed between the thin film transistor substrate and the color filter substrate.

The thin film transistor substrate includes pixels to display an image. Each pixel includes a gate line, a data line, a thin film transistor, and a pixel electrode. The gate line and the data line are respectively applied with gate and data signals and electrically connected to gate and source electrodes of the thin film transistor. The pixel electrode is electrically connected to a drain electrode of the thin film transistor.

The thin film transistor substrate is coupled with the color filter substrate to face the color filter substrate, and a liquid crystal material is injected into a space between the thin film transistor substrate and the color filter substrate, which is secured by a spacer disposed between the thin film transistor substrate and the color filter substrate. To align liquid crystal molecules of the liquid crystal material, an alignment process is performed to form an alignment layer on each of the thin film transistor substrate and the color filter substrate. The alignment layer is formed by coating an alignment layer solution on a substrate and drying the alignment layer solution.

However, the alignment layer solution is spread after crossing an area prepared for the alignment layer solution due to spreadability of the alignment layer solution, and the alignment layer is overlapped with a sealing member used to seal the liquid crystal material between the thin film transistor substrate and the color filter substrate. As a result, an adhesive force between the thin film transistor substrate and the color filter substrate decreases and moisture vapor permeability increases. Consequently, a reliability of the display panel is lowered.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present disclosure provides a display panel capable of preventing an alignment layer solution from spreading to improve reliability thereof.

The present disclosure provides a method of manufacturing the display panel.

Embodiments of the inventive concept provide a display panel including a first display substrate, a second display substrate facing the first display substrate and coupled with the first display substrate, a liquid crystal layer interposed between the first display substrate and the second display substrate, and an alignment layer disposed at a display area of at least one display substrate selected from the first and second display substrates. The selected display substrate includes a first area provided with a surface having a hydrophobic property higher than a hydrophobic property of an area adjacent to the first area.

Embodiments of the inventive concept provide a method of manufacturing a display panel. The method includes steps of manufacturing a first display substrate, manufacturing a second display substrate facing the first display substrate and coupled with the first display substrate, forming a liquid crystal layer between the first and second display substrates, and forming an alignment layer on at least one display substrate selected from the first and second display substrates. The selected display substrate includes a display area and a peripheral area surrounding the display area, the selected substrate includes a first area disposed in the peripheral area, the first area includes a surface having a hydrophobic property higher than a hydrophobic property of an area adjacent to the first area, and the manufacturing of the selected display substrate includes performing a hydrophobic treatment on the first area.

According to the above, the first area having the relatively higher hydrophobic property is disposed in the peripheral area, and thus the alignment layer solution may be prevented from spreading. Thus, the sealing member may be prevented from being contaminated due to the spreadability of the alignment layer solution, and thus reliability of the display panel may be improved.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a plan view showing a display substrate according to an exemplary embodiment of the present disclosure;

FIG. 2 is a cross-sectional view taken along a line I-I′ shown in FIG. 1;

FIG. 3 is a plan view showing a display substrate according to another exemplary embodiment of the present disclosure;

FIG. 4 is a cross-sectional view taken along a line II-II′ shown in FIG. 3;

FIG. 5 is a plan view showing a display substrate according to another exemplary embodiment of the present disclosure;

FIG. 6 is a plan view showing a display substrate according to another exemplary embodiment of the present disclosure;

FIG. 7 is a plan view showing a display panel according to another exemplary embodiment of the present disclosure;

FIG. 8 is a cross-sectional view taken along a line III-III′ shown in FIG. 7;

FIG. 9 is a cross-sectional view showing a display panel according to another exemplary embodiment of the present disclosure; and

FIGS. 10A and 10B are views showing processes of forming a first hydrophobic thin film layer on a first display substrate according to an exemplary embodiment of the present disclosure.

### DETAILED DESCRIPTION OF THE INVENTION

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

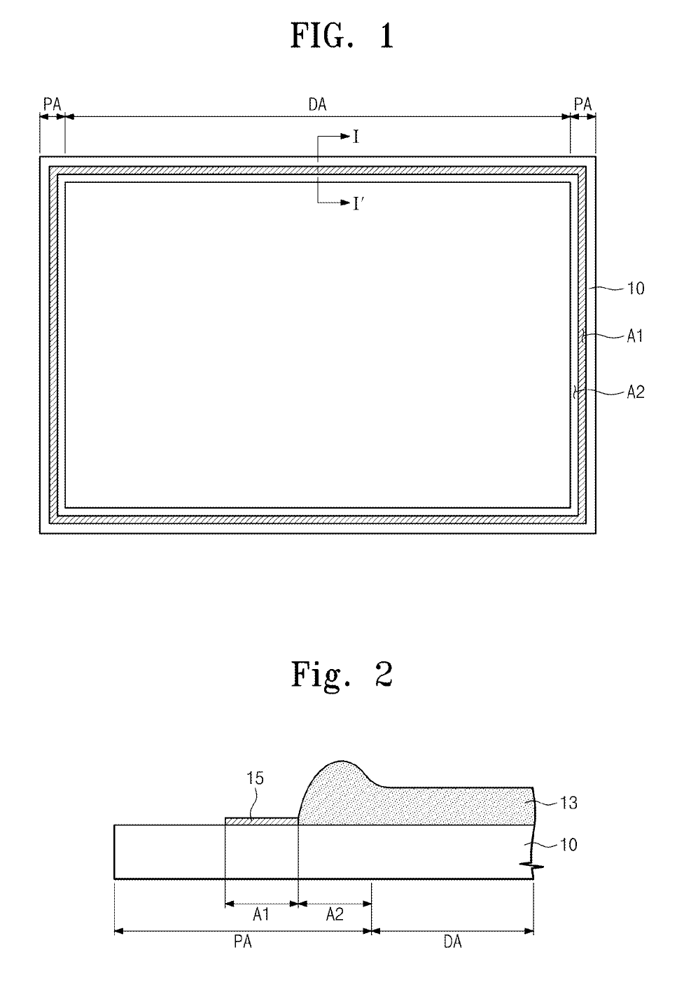

FIG. 1 is a plan view showing a display substrate 10 according to an exemplary embodiment of the present disclosure and FIG. 2 is a cross-sectional view taken along a line I-I′ shown in FIG. 1.

In reference to FIG. 1, the display substrate 10 includes a display area DA and a peripheral area PA disposed adjacent to the display area DA. The display area DA displays an image when the display substrate 10 is employed in a display panel. The peripheral area PA is disposed outside the display area DA to surround the display area DA. A light blocking material or layer is disposed in the peripheral area PA to block a light incident to the peripheral area PA.

The peripheral area PA includes a first area A1 having a hydrophobic property higher than that of an area disposed adjacent to the first area A1. The first area A1 is disposed in a closed-loop shape along the peripheral area PA. As shown in FIG. 2, the first area A1 is prepared to prevent an alignment layer solution 13 from spreading when an alignment layer is formed on the display substrate 10.

As an example, a hydrophobic thin layer 15 is disposed in the first area A1. The hydrophobic thin layer 15 includes an inorganic material or a polymer material. The hydrophobic thin layer 15 is formed in the first area A1 using a plasma process performed on the display area DA.

The first area A1 is disposed right adjacent to or spaced apart from the display area DA. In FIG. 2, the first area A1 is disposed to be spaced apart from the display area DA and a second area A2 having a hydrophilic property higher than that of the first area A1 is disposed between the display area DA and the first area A1. The second area A2 corresponds to an area of the peripheral area PA, in which the hydrophobic thin layer 15 is not disposed, or an area in which a layer having the hydrophilic property higher than that of the hydrophobic thin layer 15 is disposed.

The first area A1 is disposed at a position outer than the second area A2 as viewed relative to the display area DA. Accordingly, although the alignment layer solution 13 over-flows from the display area DA to the outside of the display area DA, the alignment layer solution 13 is prevented from over-flowing by the hydrophobic thin layer 15 without spreading to the first area A1 and held in the second area A2. Therefore, the alignment layer solution 13 may be prevented from over-flowing.

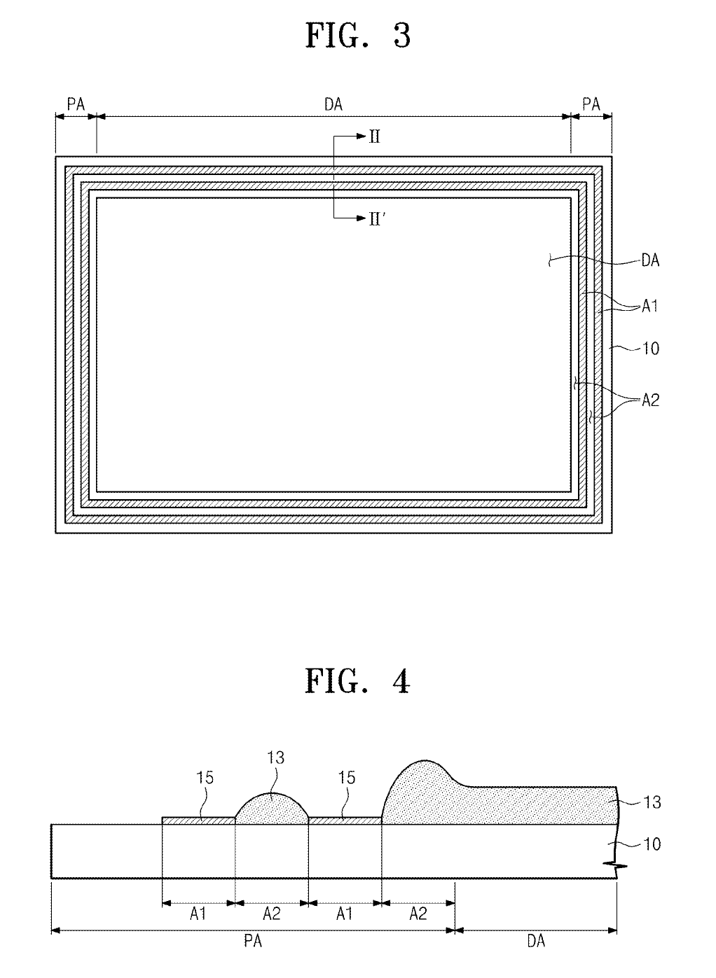

FIG. 3 is a plan view showing a display substrate according to an exemplary embodiment of the present disclosure and FIG. 4 is a cross-sectional view taken along a line II-II′ shown in FIG. 3.

In reference to FIGS. 3 and 4, a plurality of first areas A1 and a plurality of second areas A2 are disposed in the peripheral area PA, and the first areas A1 are alternately arranged with the second areas A2 in a direction from the display area DA to the peripheral area PA, i.e., a horizontal direction. Thus, the alignment layer solution 13 does not overflow the second area A2, which is disposed right adjacent to the display area DA, among the second areas A2. Although a portion of the alignment layer solution 13 overflows the second area A2 disposed right adjacent to the display area DA, the overflown alignment layer solution 13 may be held in the second area A2, which is disposed between the first areas A1, among the second areas A2.

The structure, in which two or more first areas A1 are alternately arranged with two or more second areas A2, may effectively prevent the alignment layer solution 13 from overflowing when compared with a structure in which only one first area A1 and only one second area A2 are disposed in the peripheral area PA. The number of each of the first and second areas A1 and A2 may be determined depending on a width in the horizontal direction of the peripheral area PA.

The hydrophobic thin layer 15 is formed in the first area A1, and the hydrophobic thin layer 15 prevents the alignment layer solution 13 from overflowing and prevents the spread alignment layer solution 13 to the peripheral area PA after passing through the second area A2 from entering the display area DA again.

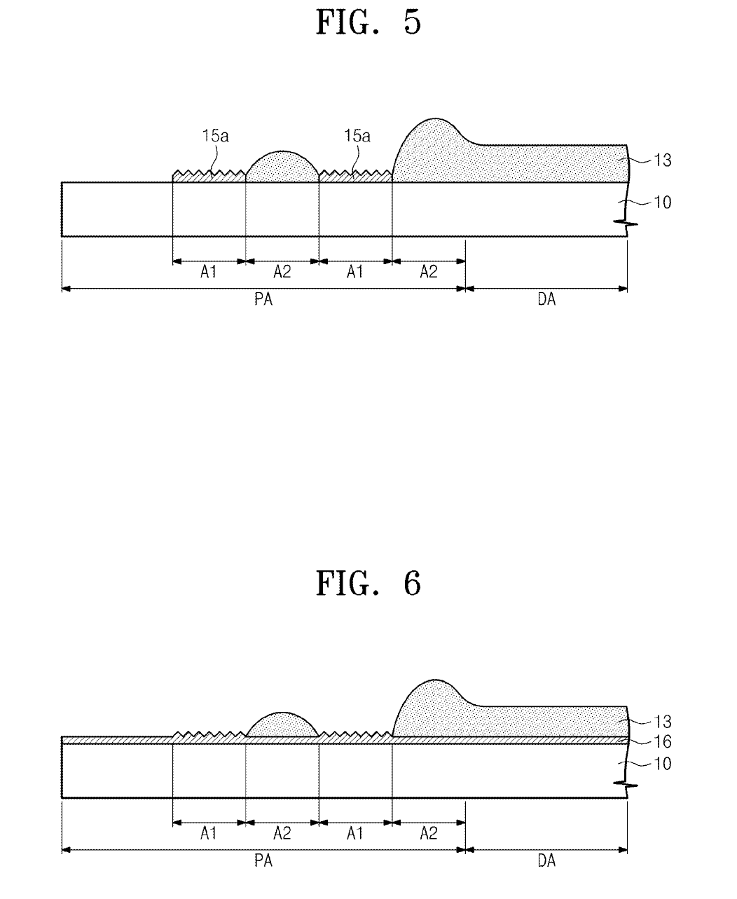

FIG. 5 is a plan view showing a display substrate according to another exemplary embodiment of the present disclosure.

In reference to FIG. 5, a hydrophobic thin layer 15a, which is formed of a material including porous or solid nanoparticles, is disposed in the first area A1 of the display substrate 10. The hydrophobic thin layer 15a is formed by coating a solution, in which a nano silica particle, a polymer compound, and acrylate derivatives are mixed with each other, in the first area A1. The hydrophobic thin layer 15a has a nano concavo-convex pattern due to the porous or solid nanoparticles, and thus the hydrophobic thin layer 15a has the relatively high hydrophobic property.

FIG. 6 is a plan view showing a display substrate according to another exemplary embodiment of the present disclosure.

In reference to FIG. 6, a base layer 16 is disposed in a peripheral area of a display substrate 10. The base layer 16 has a surface roughness that is varied depending on areas of the base layer 16. That is, the surface roughness in the first area A1 of the base layer 16 may be greater than the surface roughness in the second area A2 of the base layer 16. Thus, the base layer 16 may have the relatively higher hydrophobic property in the first area A1 and has the relatively higher hydrophilic property in the second area A2.

The surface roughness of the base layer 16 may be controlled by a laser process. When the surface of the base layer 16 is processed by irradiating the laser onto the first area A1, the surface roughness of the first area A1 increases since the surface of the first area A1 becomes uneven. The laser process may be performed by using a laser used to cut or scribe the display substrate 10.

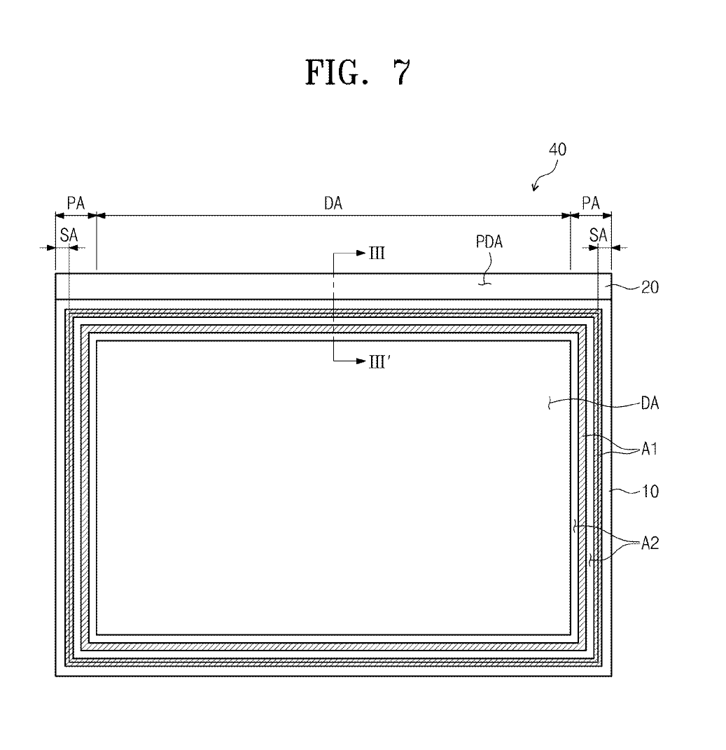

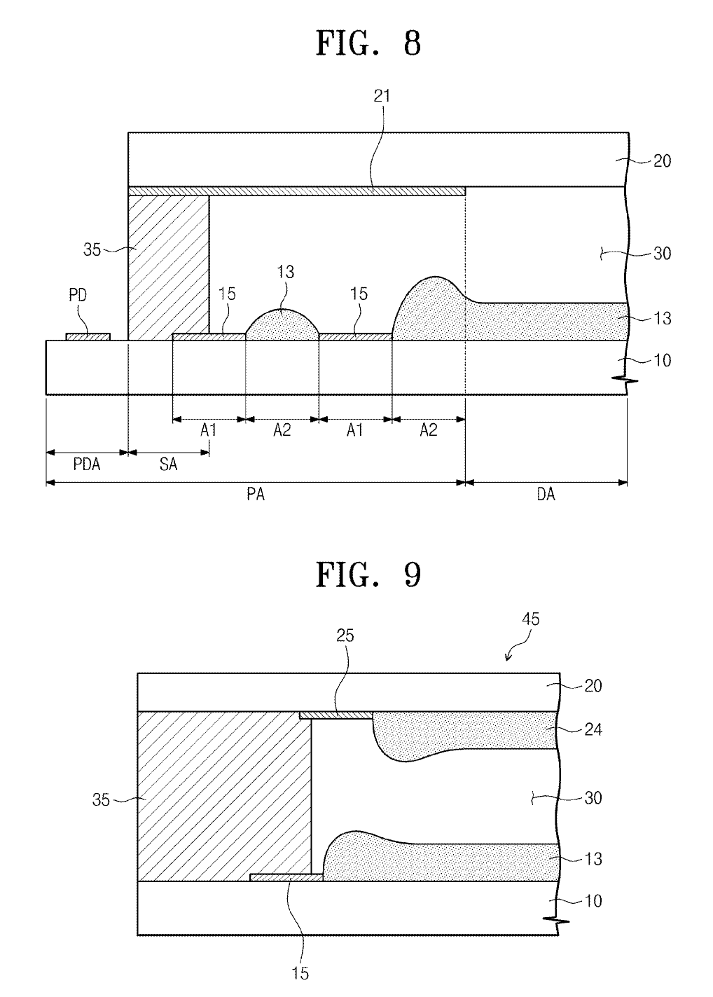

FIG. 7 is a plan view showing a display panel 40 according to another exemplary embodiment of the present disclosure and FIG. 8 is a cross-sectional view taken along a line III-III′ shown in FIG. 7. In FIGS. 7 and 8, the same reference numerals denote the same elements in FIGS. 1 and 2, and thud detailed descriptions of the same elements will be omitted.

In reference to FIGS. 7 and 8, the display panel 40 includes a first display substrate 10, a second display substrate 20 facing the first display substrate 10, and a liquid crystal layer 30 interposed between the first and second display substrates 10 and 20.

The display panel 40 further includes a sealing member 35 to couple the first display substrate 10 and the second display substrate 20. The display panel 40 includes the display area DA and the peripheral area PA and a sealing area SA in which the sealing member 35 is disposed is included in the peripheral area PA. The second display substrate 20 includes a light blocking layer 21 formed thereon to block the light leaking from the peripheral area PA.

The first area A1, in which the hydrophobic thin layer 15 is formed, is disposed in the peripheral area PA. In some embodiments, the hydrophobic thin layer 15 is disposed on one of the first and second display substrates 10 and 20; in other embodiments, the hydrophobic thin layer 15 is disposed on each of the first and second display substrates 10 and 20. In FIG. 8, the hydrophobic thin layer 15 is disposed only on the first display substrate 10 as a representative example.

The sealing member 35 is disposed at a position not overlapped with the second area A2. The sealing member 35 is not overlapped with at least the second area A2 disposed between the first area A1 and the display area DA. As an example, the sealing member 35 is disposed to overlap with the first area A1 disposed at an outermost position among the first areas A1 or is disposed at a position outer than the first area A1 disposed at the outermost position. Accordingly, the sealing member 35 may be prevented from being contaminated due to the alignment layer solution 13.

The peripheral area PA of the display panel 40 includes a pad PD disposed in an area, i.e., a pad area PDA, of the first display substrate 10, which does not face the second display substrate 20, to receive a signal from the outside of the display panel 40. The pad PD may be a gate pad to apply a gate signal to the display area DA or a data pad to apply a data signal to the display area DA.

FIG. 9 is a cross-sectional view showing a display panel 45 according to another exemplary embodiment of the present disclosure.

In reference to FIG. 9, the display panel 45 includes a first display substrate 10, a second display substrate 20 facing the first display substrate 10, a liquid crystal layer 30 interposed between the first display substrate 10 and the second display substrate 20, and a sealing member 35 coupling the first display substrate 10 and the second display substrate 20.

The display panel 45 includes a first hydrophobic thin layer 15 disposed on the first display substrate 10 and a second hydrophobic thin layer 25 disposed on the second display substrate 20. The first hydrophobic thin layer 15 prevents a first alignment layer solution 13, which is coated on the first display substrate 10 using an inkjet method, from spreading to the outside of the display panel 45, and the second hydrophobic thin layer 25 prevents a second alignment layer solution 24, which is coated on the second display substrate 20 using the inkjet method, from spreading to the outside of the display panel 45.

As an example, the first and second hydrophobic thin layers 15 and 25 are disposed to face each other or disposed not to face each other when viewed in a plan view. When the first and second hydrophobic thin layers 15 and 25 are disposed not to face each other, the first and second hydrophobic thin layers 15 and 25 are partially overlapped with each other.

When viewed in a plan view, the first area A1 is partially overlapped with the sealing member 35. As another example, the sealing member 35 is disposed at a position outside the first area A1 to be spaced apart from the first area A1.

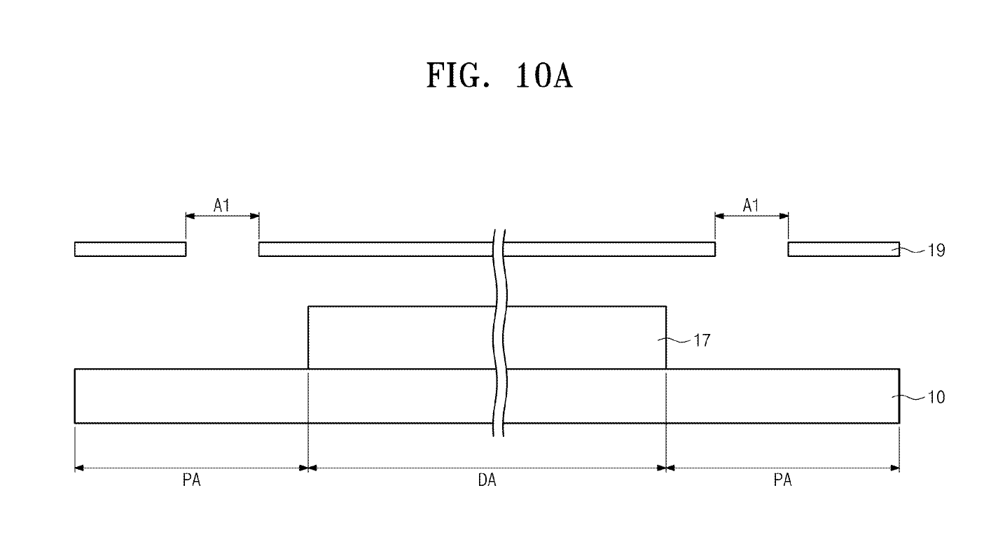

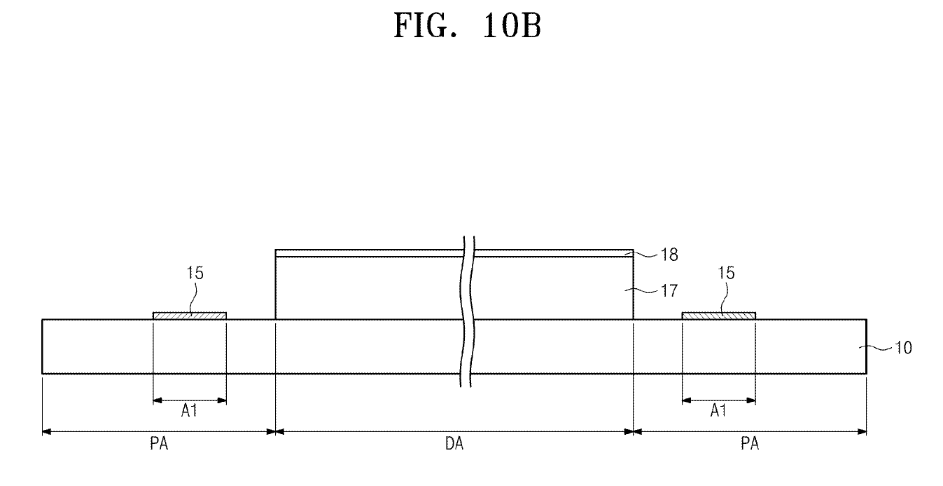

FIGS. 10A and 10B are views showing processes of forming a first hydrophobic thin film layer on a first display substrate according to an exemplary embodiment of the present disclosure.

In reference to FIG. 10A, a pixel array 17 is formed in the display area DA of the first display substrate 10. The pixel array 17 includes signal lines, thin film transistors, insulating layers, a protective layer, and pixel electrodes. The pixel array 17 may further include various color pixels, e.g., red, green, and blue pixels. According to another embodiment, the pixel array 17 may further include a light blocking layer.

For the convenience of explanation, the detailed structure of the pixel array 17 disposed on the first display substrate 10 is not shown in FIG. 10A.

The pixel array 17 is completely formed through several processes and the first hydrophobic thin layer 15 is formed using a shadow mask 19 used to perform a chemical vapor deposition process among the several processes. When the chemical vapor deposition process is performed to form a specific layer of the pixel array 17, the shadow mask 19 exposes the display area DA and covers the peripheral area PA. In this case, when a portion of the shadow mask 19, which corresponds to the first area A1 of the peripheral area PA, is opened and exposed to a plasma process, the first hydrophobic thin layer 15 is formed in the first area A1 as shown in FIG. 10B.

Among the processes of forming the pixel array 17, the first hydrophobic thin layer 15 may be formed in a process of forming an active layer 18 of the thin film transistor or a process of forming the protective layer.

According to the process of forming the first hydrophobic thin layer 15, elements included in the pixel array 17 may be changed.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display panel comprising:
a first display substrate;
a second display substrate facing the first display substrate and coupled with the first display substrate;
a liquid crystal layer interposed between the first display substrate and the second display substrate; and
an alignment layer disposed at a display area of at least one display substrate selected from the first and second display substrates, wherein the selected display substrate comprises a first area provided with a surface having a hydrophobic property higher than a hydrophobic property of an area adjacent to the first area.

2. The display panel of claim 1, wherein the selected display substrate further comprises a hydrophobic thin layer disposed in the first area.

3. The display panel of claim 2, wherein the hydrophobic thin layer comprises an inorganic material or a polymer material.

4. The display panel of claim 1, wherein the selected display substrate further comprises a second area disposed in the peripheral area and comprising a surface having a hydrophilic property higher than a hydrophilic property of the first area, each of the first and second areas is provided in a plural number in the peripheral area, and the first areas are alternately arranged with the second areas in the peripheral area.

5. The display panel of claim 4, wherein the first area has a surface roughness greater than a surface roughness of the second area.

6. The display panel of claim 1, further comprising a sealing member disposed between the first and second display substrates to couple the first display substrate and the second display substrate, wherein the sealing member is disposed in a sealing area, and the sealing area is disposed in the peripheral area.

7. The display panel of claim 1, wherein the sealing member is not overlapped with at least the second area disposed between the first area and the display area among the first and second areas.

8. A method of manufacturing a display panel, comprising:
manufacturing a first display substrate;
manufacturing a second display substrate facing the first display substrate and coupled with the first display substrate;
forming a liquid crystal layer between the first and second display substrates; and
forming an alignment layer on in a display area of at least one display substrate selected from the first and second display substrates, wherein the selected display substrate comprises a first area disposed in the peripheral area surrounding the display area, the first area comprises a surface having a hydrophobic property higher than a hydrophobic property of an area adjacent to the first area, and the manufacturing of the selected display substrate comprises performing a hydrophobic treatment on the first area.

9. The method of claim 8, wherein the performing of the hydrophobic treatment comprises forming a hydrophobic thin layer in the first area using a plasma treatment process.

10. The method of claim 9, wherein the hydrophobic thin layer comprises an inorganic material or a polymer material, which is used in the display area.

11. The method of claim 9, wherein the plasma treatment process comprises forming the hydrophobic thin layer using a shadow mask used in a chemical vapor process among processes of forming the selected displays substrate.

12. The method of claim 8, wherein the performing of the hydrophobic treatment comprises forming a hydrophobic thin layer in the first area by coating a solution obtained by mixing a nano silica particle, a polymer compound, and acrylate derivatives.

13. The method of claim 8, wherein the performing of the hydrophobic treatment comprises:
forming a base layer; and
irradiating a laser to a predetermined portion of the base layer to increase a surface roughness of the first area and enhance the hydrophobic property of the first area.
